(19) United States
(12) Patent Application Publication
(10) Pub. No.: US 2023/0023938 A1
(43) Pub. Date: Jan. 26, 2023

(54) MOUNTABLE HANDS-FREE APPLICATOR DEVICE

(71) Applicant: Shimmy Beauty LLC, Chicago, IL (US)

(72) Inventor: Gigi Lubin, Chicago, IL (US)

(21) Appl. No.: 17/380,218

(22) Filed: Jul. 20, 2021

(51) Int. Cl. A45D 34/04

(52) U.S. Cl. CPC A45D 34/04; F16M 13/022

(57) ABSTRACT

Provided herein is a surface mountable panel for hands-free application of body product or medication comprising, a first panel portion for mounting, a body contact surface on said panel and containing or comprising body product to be applied, and which is compressible and is 3D in shape to mimic body portion topography when in body contact during application of body product.

### FIELD OF THE INVENTION

The present invention is directed to mountable, such as wall mountable, hands-free body product application devices and methods.

### BRIEF DESCRIPTION OF THE DRAWINGS

FIG. 1 illustrates a side prospective view of a preferred embodiment of features of the invention.

FIG. 2 illustrates a frontal plan view of a preferred embodiment of additional features of the invention.

FIG. 3 illustrates a perspective view of optional preferred features of the invention.

FIG. 4 illustrates in frontal plan view yet another preferred embodiment of the invention

### DETAILED DISCUSSION OF PREFERRED EMBODIMENTS

It is to be understood that the disclosed embodiments described herein and depicted in the figures are merely exemplary of the invention, which can be embodied in various forms. Therefore, specific structural and functional details disclosed herein are not intended to be interpreted as limiting, but merely as a basis for the claims and as a representative basis for teaching one of ordinary skill in the art to variously employ the invention in virtually any appropriately detailed structure as limited by one's own imagination. Various modifications and structural changes are contemplated without departing from the spirit of the invention and within the scope and range of equivalents of the claims.

In its broadest sense, the invention is a mountable, such as wall-mountable—or any surface mountable—hands-free application device and method, for any body products, such as body lotions, sunscreen/sunblock, oils, body oils or medications and the like. In use a person will have applied a body application product, such as a lotion product, to an applicator facing, and then contact a body portion with the facing to apply the product hands-free, such as shimmying up against it. The device encompasses a support panel which may be removably attached to any surface, such as, without limitation, a wall surface, door or shower or bath tub wall, or sauna, in both indoor and outdoor environments, and in some embodiments may contain removable product applicator sheets for application of any product intended for human body application, in a hands-free manner. The application surface area also preferably mimics to a generic degree in 3-D manner the surface topography of a body portion for maximum product application to a desired body portion.

Having discussed the invention in general terms, a detailed discussion of the figures posing some preferred embodiments follows.

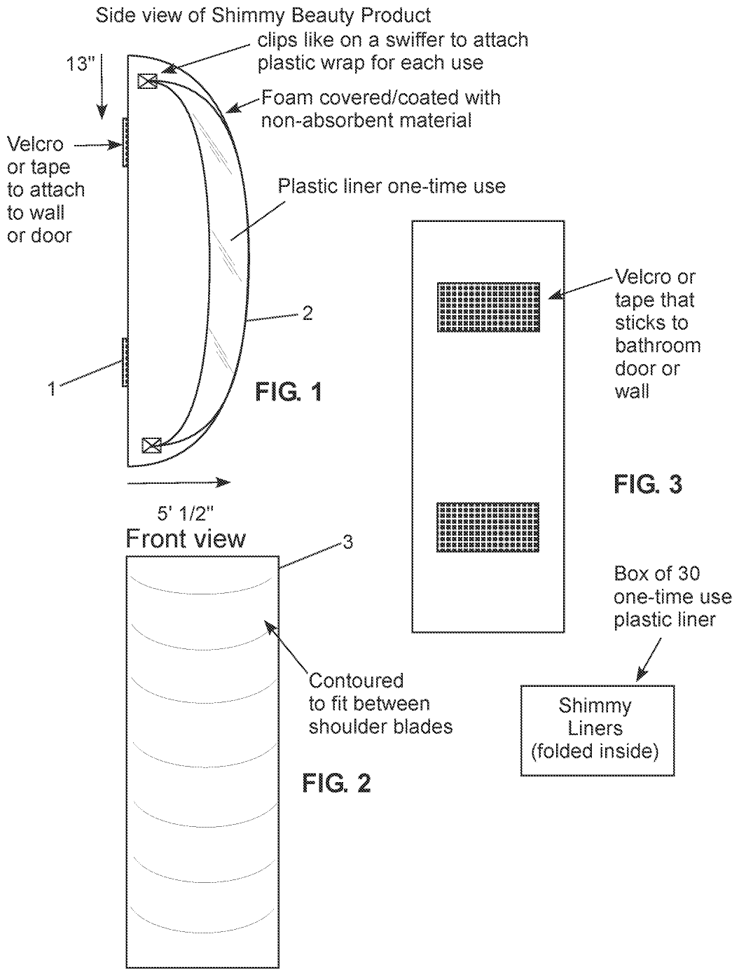

FIG. 1 illustrates a side perspective view of a preferred embodiment of a support panel 1, which can be removably attached to any surface, such as a wall surface, door, shower or bath tub wall, sauna surface and the like by any removable attachment means, such as a peel and stick surface, preferably a non-permanent type sticking surface, Velcro fasteners, suction cups, tape, mechanical means, hooks, etc.

Those skilled in the art will recognize that support panel 1 can be structured in any number of ways and be composed of any material, for example, to be of reduced weight, but of desired strength for repeated use over time such as, for example, plastics, including, without limitation, polyethylene, such as polyethylene terephthalate (PETE), high density polyethylene (HDPE) and low density polyethylene (LDPE), ABS plastic, polyvinyl chloride (PVC), polyurethane, polypropylene, polystyrene, polycarbonate, acrylic, nylon, fiberglass and polylactic acid. Support panel 1 may, for example, also be manufactured from hybrid materials, such as a durable silicone material for use in wet and moist environments, and desirable for its non-toxic qualities as to possible body contact. Preferably support panel 1 is manufactured from water resistant material, and some non-limiting and non-exclusive examples of desirable qualities contemplated, depending on manner and environment of use, include, materials that are inexpensive, lightweight and shatter resistant, as well as recyclable, materials known for ease of manufacture, such as thermoplastic manufacturing, eco-friendly materials, preferably BPA-free, materials resistant to oil, moisture, salt spray, fading, insects, splintering, warping and other hazardous environmental exposure, along with chemical resistance and resistance to impact deformation.

As shown in FIG. 2, a plan view embodiment of support panel 1 in FIG. 1, support panel 1 in one preferred embodiment is manufactured with, or provided with, a contoured outer body contact surface with a topological body contact portion 2 to mimic body curvature and body portion topography and, for example, fit generally between a user's shoulder blades in a generic fashion if a back body portion is having a product applied. This surface portion may be molded as such with panel 1, for example, as a single plastic or silicone product, or may in some embodiments be added or co-joined as a separate surface, such as a foam surface with a face coated with a non-absorbent material, preferably water resistant, which “gives” or mimics a particular person's body portion topography, e.g. back portion, when pressed or compressed against this surface in use to apply a product.

As also shown in FIG. 1, surface 2 may in some embodiments also be provided with a disposable liner 3, such as for a one-time usage, and attached to surface 2 by any removable attachment means, such as a clip on holder 4. This may be, for example, a “press-type” clip, such as used in disposable mop facings, but any suitable attachment means is contemplated. Liner 3 may be made of plastic, paper or any material, again, preferably water resistant, and is preferably of a material suitable to hold product to be applied for transfer to a body portion when in use.

As mentioned, surface 2 may be manufactured with support panel 1 as a single piece to simplify fabrication. Otherwise surface 2 can be mated to support panel 1 by any suitable manner, such as by plastic welding, glue, or mechanical means, such as screws and rivets and the like.

Preferably material for surface 2 is used that may be pressed and vectored against a body portion when a person's body portion is in contact, such as when a person shimmies against it to apply a body product lotion, to generally conform to one's body portion topography for suitably desired coverage and application of product, such that a one-size-fits-all product may be employed. Otherwise ranges of sizes to mimic body portion topography, such as a back portion, such as small, medium and larger sizes are also contemplated.

As can be appreciated, such a product provides an ideal solution for club spas, pool environments and other settings to apply a hands-free body lotion or product to hard to reach and generally inaccessible body regions, without the need for another party's interaction, as desired. The disposable outer liner 3 option provides maximum sanitary options as well. Notwithstanding the option or embodiment employed, body contact material may be made from any human body epidermis compatible material.

As shown in FIG. 3, many optional attachments are also contemplated, such a reservoir of additional disposable liners 3.

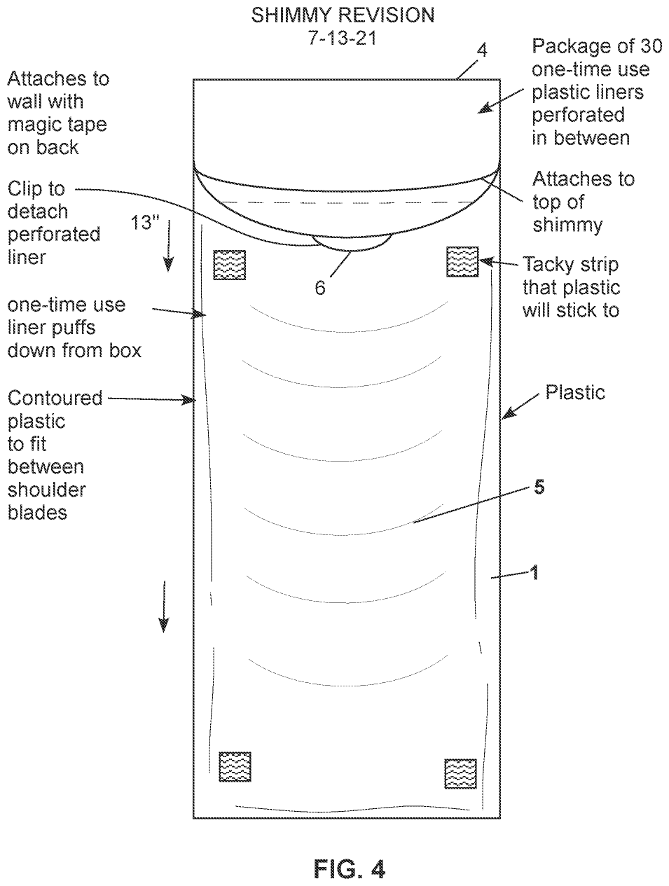

FIG. 4 illustrates in plan view yet another contemplated non-limiting embodiment of the invention, showing panel 1 provided with a reservoir package 4 of pull down one-time use liners 5, such as a roll of liners, which, for example, can be pulled down over panel 1 for use and easily separated by sections by perforations after use to use a next section. The reservoir liners 5 can be preloaded with product to be applied, or have product applied, such as squirted or sprayed on, prior to use. In use, a person can pull down a liner section 5 from reservoir 4, such as by pull down portion 6, with product pre-applied or thereafter applied, and shimmy against it for body portion application as contemplated. The used section 5 can then be easily separated and discarded for further use of the product.

Additionally, it is contemplated that the mountable device may be mounted on any surface for use at any angle from vertical to horizontal and any angle in between, such as on the back of an adjustable lounge chair.

Yet additional embodiments contemplated include, for instance, and without limitation, heating elements which can be press activated or plug in; an optional vibration/massage element; and/or an optional product dispensing function/structure, such as an included product reservoir with is contact functional.

While the invention has been described with particular reference to some preferred embodiments in the interest of complete definiteness, it is to be understood that it may be embodied in a variety of forms such as exemplified above without limitation diverse from these specifically shown and described without departing from the spirit and scope of the invention and defined by the appended claims.

I claim:

1. A surface mountable panel for hands-free application of body product or medication comprising,
a first panel portion for mounting,
a body contact surface on said panel and containing or comprising body product to be applied, and which is compressible and is 3D in shape to mimic body portion topography when in body contact during application of body product.

2. The panel of claim 1 wherein body contact surface comprises a detachable surface material for one or more uses.
